(19) United States
(12) Patent Application Publication
(10) Pub. No.: US 2019/0078704 A1
(43) Pub. Date: Mar. 14, 2019

(54) A FASTENER ASSEMBLY

(71) Applicant: JCCO 330 LIMITED, Manchester (GB)

(72) Inventor: Paul Davidson, Macclesfield (GB)

(21) Appl. No.: 16/093,743

(22) PCT Filed: Mar. 23, 2017
(86) PCT No.: PCT/GB2017/050819

§ 371 Date: Oct. 15, 2018

(30) Foreign Application Priority Data
Apr. 15, 2016 (GB) 1606601.1

(51) Int. Cl. F16L 3/11; F16L 3/24; F16B 2/14; F16B 21/16; F16B 7/04; F16L 3/10

(52) U.S. Cl. CPC F16L 3/11; F16L 3/24; F16B 2/14; F16L 3/1091; F16B 7/0473; F16L 3/1016; F16B 21/16

(57) ABSTRACT

Disclosed is a fastener assembly (100) for use with a generally elongate member (1) having formed therein a plurality of recesses (10), the fastener assembly (100) comprising: an engaging member (2A, 2B), having a generally tapered portion, arranged to receive the generally elongate member (1); a container (3, 203, 303, 403, 503) arranged to substantially enclose the engaging member (2A, 2B); and a retaining member (4) for securing the engaging member (2A, 2B) and container (3, 203, 303, 403, 503) on the generally elongate member (1), wherein the generally tapered portion of the engaging member (2A, 2B) has at least one projection (20) arranged, in use, to enter at least one of the plurality of recesses (10) of the generally elongate member (1).

The present invention relates to a fastener assembly. Fastener assemblies according to an embodiment of the invention may find use in a variety of different situations, some of which will be described later. However, by way of illustration, such uses may involve pipe hanging systems, which allow pipes, cables and like to be suspended from a ceiling. Other example uses will become apparent later.

It is common to run networks of pipes for carrying fluids from a ceiling or along a wall, using a system of brackets, mounting points and rods, connected between the pipe and the support. Such pipe networks are frequently found in basements, cellars, ceiling voids and the like. The pipes in question may be used for conveying water, waste, gas or any other fluid which needs to be carried from one point to another in a building.

In the prior art, pipe support brackets are attached around a pipe and a coupling point located at the top of the bracket is connected to a length of threaded rod which is screwed into the bracket at a first end, and to a support point at a second end. The support point may be in the form of an anchor provided in a ceiling or in the form of a bracket extending from a wall. The anchor in the ceiling may be a specific fastener which is permanently installed in the ceiling, or may be in the form of an attachment to a rail system.

A particular problem in installing prior art pipe support or hanging systems is that work is performed overhead, which can be strenuous and awkward. The threaded rods which are routinely used to couple the pipe bracket to the support structure require cutting to length using a hacksaw, which often results in sharp portions remaining which can pose an injury risk to an installer. Screwing in the rods and adding locking bolts is time consuming and awkward.

It is an aim of embodiments of the present invention to address shortcomings in the prior art, whether mentioned herein or not.

According to an aspect of the present invention, there is provided a fastener assembly for use with a generally elongate member having formed therein, a plurality of recesses, the fastener assembly comprising: an engaging member, having a generally tapered portion, arranged to receive the generally elongate member; a container arranged to substantially enclose the engaging member; and a retaining member for securing the engaging member and container on the generally elongate member, wherein the generally tapered portion of the engaging member has at least one projection arranged, in use to enter at least one of the plurality of recesses of the generally elongate member.

In an embodiment, the generally tapered portion of the engaging member comprises a pair of members arranged, in use, either side of the generally elongate member, at least one of the pair of members being provided with an inwardly-directed projection for entering at least one corresponding recess provided in the generally elongate member.

In an embodiment, each member of the pair of members is provided with an inwardly-directed projection.

In an embodiment, each of the inwardly-directed projections is arranged to enter a different recess provided in the generally elongate member.

In an embodiment, the generally tapered portion is generally tapered in a state either before or after receiving the generally elongate member.

In an embodiment, the retaining member is arranged to reside in a gap between respective faces of the container and the engaging member and to prevent relative movement of the container and the engaging member, and so secure the fastener assembly in position on the generally elongate member.

In an embodiment, the container is arranged to further comprise a wedge element arranged, in use, to secure the container in a suitable recess and so anchor it is position.

In an embodiment, the container is arranged to comprise two engaging members arranged back to back and in linear configuration so that the fastener assembly is operable to connect two generally elongate members.

In an embodiment, the container is arrange to comprise an upper half of a pipe-hanger, which is adapted to couple to a lower half of a pipe hanger, all operable to support a pipe or other conduit.

In an embodiment, the container is arranged to reside to within a rail member, such that the container is arranged to be retained with the rail member, in use.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

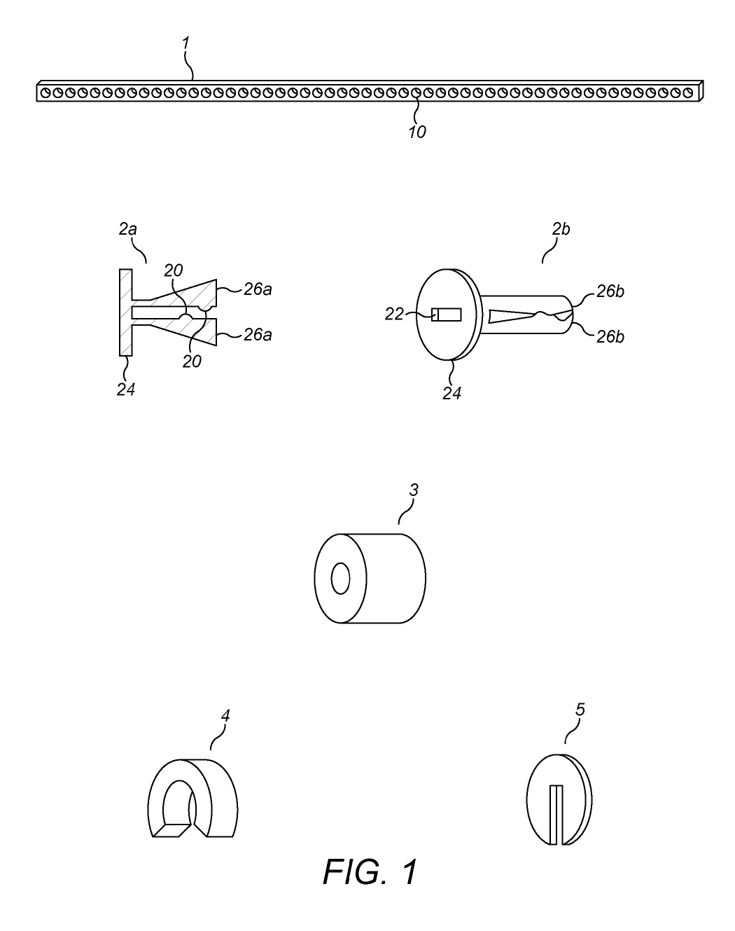

FIG. 1 shows various component parts related to an embodiment of the present invention;

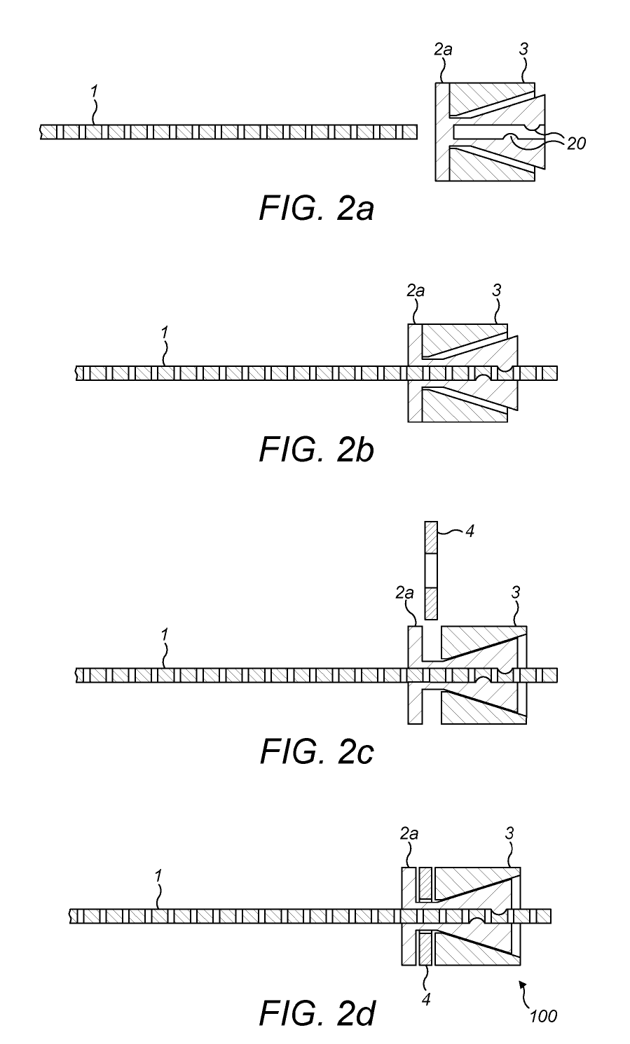

FIGS. 2a-2d show various stages in the application of a fastener assembly according to an embodiment of the present invention;

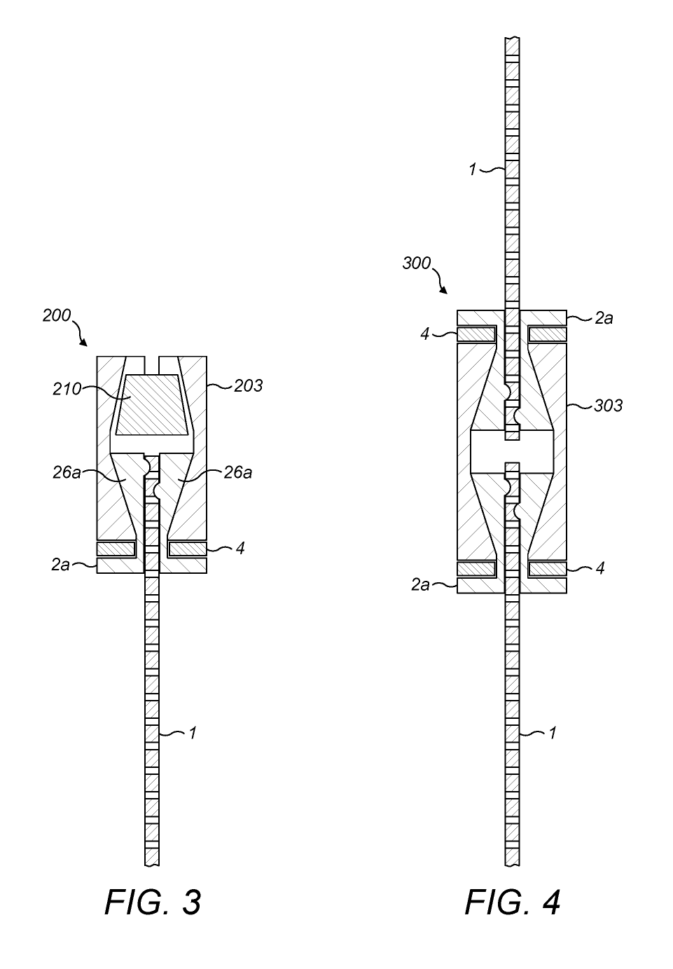

FIG. 3 shows an anchor assembly according to an embodiment of the present invention;

FIG. 4 shows a connector according to an embodiment of the present invention;

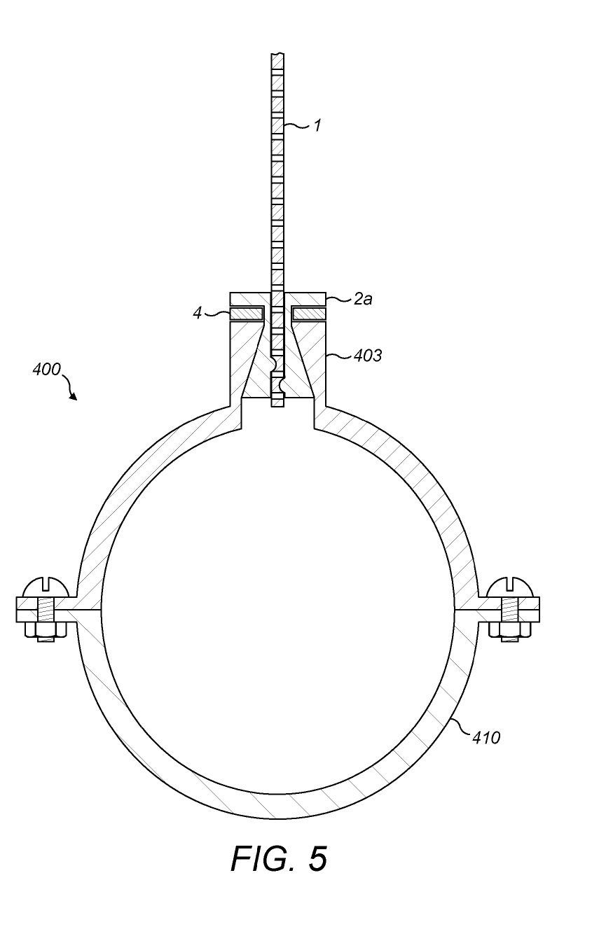

FIG. 5 shows a pipe clamp according to an embodiment of the present invention; and

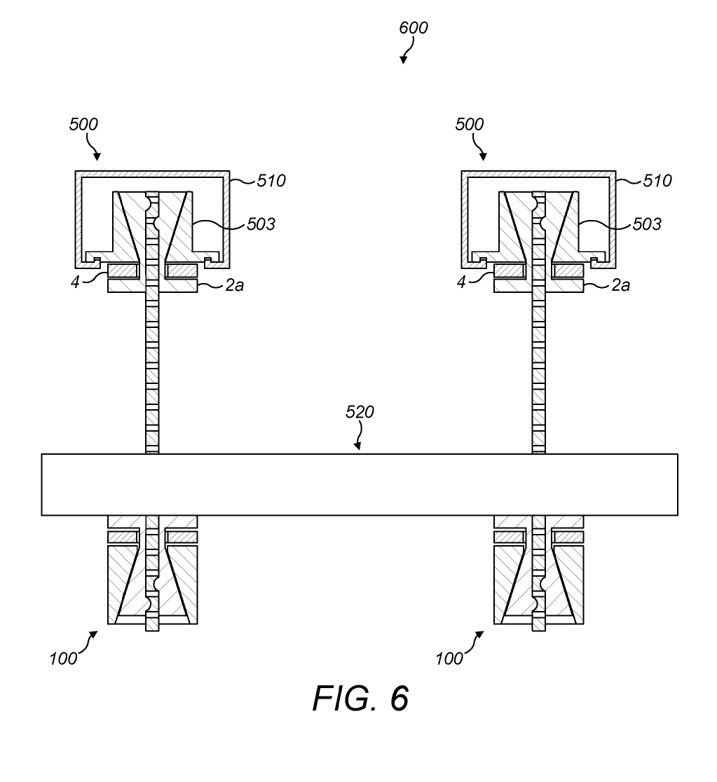

FIG. 6 shows a trapeze support according to an embodiment of the present invention.

FIG. 1 shows various component parts which make up a fastener assembly 100 according to an embodiment of the invention. FIGS. 2a-2d show the steps involved in attaching the assembly 100 to an elongate rod 1. The fastener assembly 100 is shown in a fully assembled state in FIG. 2d.

The fastener assembly 100 comprises an engaging member 2a or 2b, a container 3 and a retaining member 4. There is optionally provided a spacer 5, if fine adjustment is required. The engaging member may take one of two different configurations as shown by parts 2a and 2b.

The function of the engaging members 2a and 2b are the same, but the configuration differs. Each will be described in turn.

Engaging member 2a comprises a generally circular planar plate 24, provided with a slot 22 for receiving the generally elongate member or bar 1. Disposed on an inner surface of the plate 24 are a pair of relatively resilient members 26a. These members 26a are disposed either side of the slot 22. Each member 26a is provided with a projection 20 arranged to engage with the bar 1 once it is inserted into the slot 22. The general profile of the members 26a is tapering from a distal end, to a narrower end, proximal to the plate 24.

In use, engaging member 2a is formed to reside within container 3. Container 3 has a substantially regular cylindrical outer profile, but a tapering internal profile. This is best seen in FIG. 2a. In practice, engaging member 2a and container 3 will be formed together and will, in normal use, be inseparable.

Engaging member 2b is configured differently and comprises a generally circular planar plate 24, provided with a slot 22 for receiving the generally elongate member or bar 1. Disposed on an inner surface of the plate 24 are a pair of relatively resilient members 26b. These members 26b are disposed either side of the slot 22. Each member 26b is provided with a projection 20 arranged to engage with the bar 1 once it is inserted into the slot 22. The general profile of the members 26b takes the form of a substantially constant diameter cylinder.

In use, the engaging members 2a and 2b operate similarly.

In the case of engaging member 2a, it is provided located inside container 3. To attach the fastener assembly 100 to the rod 1, the rod 1 is introduced into the slot 22 of engaging member 2a. This is shown in FIG. 2a, which shows the container 3 and other parts in cross-section.

In FIG. 2b, it can be seen that continued insertion of rod 1 into the slot 22 causes the tapering members 26a to be pushed slightly apart as the rod 1 enters and for the projections 20 to coincide with and enter one or more of the apertures 10 provided in the rod 1. The projections 20 are positioned and dimensioned so that if, as in this case, there are two projections, their relative spacings coincide with the relative spacings of the apertures 10 so that the fastener 100 moves between discrete stable positions along the bar 1.

It should be noted that a different number of projections 20 may be provided as required in particular cases. For instance, embodiments will function with only a single projection 20, but performance is improved if two or more are provided. Further, if more than one projection 20 is provided, it is preferable that these are positioned such that each engages with a different respective aperture 100 in bar 1. It is further preferable if the projections are located so as to be positioned on opposing sides of the bar as it enters the assembly 1, as shown in FIG. 2a-2d.

In the configuration shown in FIG. 2b, the engaging member 2a will be relatively fixed in position, but can be moved easily. The container 3, which houses the engaging member 2a loosely will be relatively free to move, in the sense that there will be some ‘play’ between it and the engaging member 2a.

In order to lock the fastener in position, the retaining member 4 is introduced, as shown in FIG. 2c, into the space provided between the engaging member 2a and the container 3. In this way, the tapered outer profile of engaging member 2a abuts the tapered inner profile of container 3, and the retaining member 4 maintains the parts in this position, effectively locking the fastener assembly in position, as shown in FIG. 2d.

The retaining member 3 is substantially disc-shaped, sized to correspond to the engaging member 2a and container 3, but with a slot provided to accommodate the bar 1.

In some circumstances, perhaps to accommodate manufacturing tolerances, it may be necessary to provide an additional spacer 5 alongside the retaining member 4, although it is not expected to be necessary in most cases.

In the case of the alternative engaging member 2b, the mode of operation is similar. The member 2b also resides within container 3, which is identical to the container 3 already described. However, in this case, the pair of members 26b are arranged to be in contact, as shown in FIG. 1. As the bar 1 is introduced into the slot 22, the members 26b are pushed apart, and the pair of projections 20 operate as described previously to fit into the apertures 10 of the bar 1. Once the bar 1 has been inserted, the outer profile of the members 26 takes on a tapered shape and the engaging member can then be retained in position within the container 3 and hence on the bar 1, as described previously, by use of the retaining member 4.

The bar 1 is usually formed from a metal, such as steel, although it could be formed from other materials such as plastics materials.

The components of the fastening member 100 are usually formed from a plastics material, such as nylon or any other suitable plastics material. Alternatively, the components may be formed from a metallic material, or may comprise a mixture of different materials.

Once the retaining member 4 is in place, then the fastener will be retained in a fixed position on the bar 1. In order to remove the fastener, then the retaining member 4 may be removed (along with any spacer 5, if fitted) and the assembly process may be reversed to release the engaging member 2a, 2b and remove the fastener assembly completely.

In order to better understand how a fastener assembly according to an embodiment of the present invention may be utilised, it is instructive to examine sample applications thereof.

FIG. 3 shows a ceiling-anchored configuration, generally designated 200. In use, the container 203 is positioned in a suitable aperture in a ceiling or other supporting surface. Once the container 203 is in-situ, a wedge 210, which is provided in a void within the container 203 is forcibly driven upwards into the ceiling. This has the effect of driving outwards the sides of the container 203 and so securing the container 203 firmly within the ceiling. The wedge 210 and/or the interior and/or exterior of the container in which it resides may be provided with teeth to secure it more permanently.

The force required to drive the wedge 210 into position may be provided by means of a suitable tool which passes through the slot in container 203 and also through the slot in engaging member 2a.

In order to secure a rod 1 in the assembly 200, the rod is introduced through the slot in the container and the engaging member 2a, which has the effect of pushing apart the members 26a, as described previously. Once the rod 1 has been inserted to a sufficient depth, the retaining member 4 is introduced which has the effect of locking the bar 1 firmly in position within the ceiling and providing a structure from which an item may be securely hung.

As will be appreciated, this process is quick, easy and avoids the need for any power tools, once the initial aperture in the ceiling has been drilled. The remaining operations are manual, and minimise the risk of injury to a fitter carrying out the tasks.

If it desired to join two lengths of bar 1 together, then a different embodiment of the invention may be used, as shown in FIG. 4. The linear connector 300, essentially functions as two fastener assemblies 100 connected back to back and formed as a single part.

One end of the connector 300 operates exactly as set out for the fastener assembly 100 as previously described and shown in FIG. 2a-2d. The other end is a mirror image and operates in an identical manner. The individual containers 3 of fastener assembly 100 are, in this embodiment, replaced with a dual container 303 which houses two engaging members 2a.

A further embodiment is shown in FIG. 5. This takes the form of a pipe hanger, generally designated 400. In this embodiment, the container 3 is replaced by an upper half of a pipe hanger bracket 403, which is coupled to a lower half of a pipe hanger bracket 410, and secured by one or more nuts, bolts or other fasteners.

The upper half of the pipe hanger bracket 403 is arranged substantially identically to the container 3, insofar as it cooperates with engaging member 2a to fasten to bar 1. However, upper bracket half 403 differs in that in incorporates a generally semi-circular portion dimensioned to match a lower half 410 and to accommodate a pipe (not shown), hung from the ceiling.

Such pipe hanging arrangements may be provided at discrete points along the length of a pipe and act to support it. The upper end of the bar 1 may be secured into a ceiling by means of the assembly shown in FIG. 3.

A further embodiment of the invention is shown in FIG. 6. This embodiment provides a so-called trapeze arrangement, generally designated 600. It comprises a pair of rail assemblies 500, which are secured to a ceiling or other supporting surface, usually by means of a simple screw or other fixing arrangement.

Each rail assembly 500 comprises an elongate rail member 510, which has a substantially C-shaped cross-section. Positioned at discrete locations along the length of the rail member 500, there is a fastener assembly, essentially as described already, comprising engaging member 2a, container 503 and retaining member 4, all arranged to support bar 1, which is suspended therefrom.

The operation of the fastener assembly is as already described. The difference in this case is that the container 503 has an external profile allowing it to sit within the C-shaped rail member 510 and be retained thereby. The container 503 may slide along the length of the rail member 510 so as to be located as required.

Once the container 503 is located as required, then the rod 1 can be introduced into the assembly 500 as described previously, to securely fix it in position. Once a pair of assemblies 500 are located, as shown, then a tray 520 can be positioned to be suspended from the bars 1. The tray 520 is fixed in position by means of a pair of fastener assemblies 100, fixed below it, as described previously. The tray 520 can be used to accommodate cable runs, gas pipes, water pipes or other service, as required.

Multiple layers of trays 520 can be assembled by means of further trays and further fastener assemblies 100, as required.

The various example embodiments described in connection with FIGS. 1-6 should not be construed as limiting, and serve only to demonstrate the flexibility offered by the present invention, which can be adapted to implement a range of different fastening/fixing functions. The skilled person will readily appreciate that minor modifications, falling within the scope of the attached claims, can be made to yield a variety of different configurations for different uses.

Embodiments of the invention offer advantages in terms of the speed of deployment and ease of installation. In particular, the need to avoid use of saws to cut threaded metal rods, used in the prior art, avoids a particular safety problem. The elongate bars 1 used in embodiments of the invention are readily available and more easily trimmed to size than the alternative threaded rods used before.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A fastener assembly for use with a generally elongate member having formed therein, a plurality of recesses, the fastener assembly comprising:
an engaging member, having a generally tapered portion, arranged to receive the generally elongate member;
a container arranged to substantially enclose the engaging member; and
a retaining member for securing the engaging member and container on the generally elongate member, wherein the generally tapered portion of the engaging member has at least one projection arranged, in use to enter at least one of the plurality of recesses of the generally elongate member.

2. The fastener assembly of claim 1 wherein the generally tapered portion of the engaging member comprises a pair of members arranged, in use, either side of the generally elongate member, at least one of the pair of members being provided with an inwardly-directed projection for entering at least one corresponding recess provided in the generally elongate member.

3. The fastener assembly as claimed in claim 2 wherein each member of the pair of members is provided with an inwardly-directed projection.

4. The fastener assembly of claim 3 wherein each of the inwardly-directed projections is arranged to enter a different recess provided in the generally elongate member.

5. The fastener assembly as claimed in claim 1, wherein the generally tapered portion is generally tapered in a state either before or after receiving the generally elongate member.

6. The fastener assembly as claimed in claim 1 wherein the retaining member is arranged to reside in a gap between respective faces of the container and the engaging member and to prevent relative movement of the container and the engaging member, and so secure the fastener assembly in position on the generally elongate member.

7. The fastener assembly as claimed in claim 1, wherein the container is arranged to further comprise a wedge element arranged, in use, to secure the container in a suitable recess and so anchor it is position.

8. The fastener assembly as claimed in claim 1, wherein the container is arranged to comprise two engaging members arranged back to back and in linear configuration so that the fastener assembly is operable to connect two generally elongate members.

9. The fastener assembly as claimed in claim 1, wherein the container is arrange to comprise an upper half of a pipe-hanger, which is adapted to couple to a lower half of a pipe hanger, all operable to support a pipe or other conduit.

10. The fastener assembly as claimed in claim 1 wherein the container is arranged to reside to within a rail member, such that the container is arranged to be retained with the rail member, in use.

11. A trapeze assembly comprising:
two fastener assemblies as claimed in claim 1, wherein the container is arranged to reside to within a rail member, such that the container is arranged to be retained with the rail member, in use;
a generally elongate rod suspended from each fastener assembly;
a tray; and
two further fastener assemblies, as claimed in claim 1, arranged to support the tray.

12. (canceled)
